(19) United States
(12) Patent Application Publication
(10) Pub. No.: US 2003/0145528 A1
(43) Pub. Date: Aug. 7, 2003

(54) Plate body fastening structure

(76) Inventor: Chor-Beng Liew, Kina Balu (MY)

Correspondence Address: Chor-Beng Liew, P.O. Box No.6-57, Chung-Ho, Taipei, 235, TW

(21) Appl. No.: 10/060,357

(22) Filed: Feb. 1, 2002

(51) Int. Cl. E04H 14/00; E04F 19/00; G09F 7/18

(52) U.S. Cl. 52/27; 52/38

(57) ABSTRACT

The present invention provides a plate body fastening structure, mainly, a concave slot with a proper depth is preserved on a plane to be fastened, such as the outer wall of a building, the wall plane of a highrise, the floor plane at a doorway or an indoor wall; the said concave slot can be inserted by a figure plate, such as a labeling plate, a door rug, a writing or painting in smaller volume; a press stick is respectively and forcedly inserted between the peripheral sides of the figure plate and the inner wall plane of the concave slot; through the fastening of the said press stick, the figure plate can be rapidly and specifically positioned on the plane to be fastened.

### BACKGROUND OF THE INVENTION

1) Field of the Invention

The present invention relates to a plate body fastening structure, more especially to a concave slot with a proper depth preserved on a plane to be fastened for the insertion of a figure plate, such as a labeling plate, a door mat, a writing or painting in a smaller volume; a press stick is forcedly disposed between the concave slot and the figure plate to rapidly and specifically position the figure plate on the plane to be fastened, thereby to make the figure plate variable and convenient for use.

2) Description of the Prior Art

Accordingly, since cities have many highrise buildings, in order to distinguish and make the unique features of each building outstanding and easy for people to recognize and search, in addition to the individual designing style, a building is usually entitled with a name, for example, The Central Building, The Mitsubishi Automobile and The Chinese Benz, for impressing people and for helping recognition and search.

Usually, when conducting the labeling work on a building, some of the industrials engrave writings on a marble plate body or cast writings on a metal plate to be fastened on the outer wall of a building; wherein, a engraved marble plate body is affixed to the outer wall of a building along with the ceramic tiles by the cement for the labeling purpose.

The way of using the cement to affix the marble plate onto the outer wall of a building is very popular; however, under the situation of economic depression, once a company is moved or closed, a new company will move into the same building; the old marble labeling plate has to be removed first before the new sign is put on; since the old one is affixed by the cement, the adjacent ceramic tiles and cement will exfoliate when the old labeling plate is removed, thereby, the ceramic tiles around the new sign have to be mended or replaced; therefore, the detachment and fastening of this kind of building labeling plate is not only troublesome and time-consuming, but also causes the color difference between the mended and the original ceramic tiles; that makes the entire building look not very pleasant.

The way of using individual and three-dimensional metal writings or casting writings on a metal plate body to be nailed onto a building has shortcomings also, for example, if weathered for a long time, the metal parts oxidize, the luster thereof dulls and even corrosion happens; furthermore, to fasten by nailing might damage the ceramic tiles and crack the outer wall; therefore, the shortcomings of affixing a marble plate body or casting writing on a metal plate body to be fastened on the outer wall of a building for labeling have to be improved.

Furthermore, usually a sticker or a three-dimensional writing is pasted to a labeling plate for indicating the title of a company on certain floor; however, this way of pasting not only might incline, tilt or drop the writings, but also leave stains on the labeling plate replaced by a new sign for a new company; that also makes the appearance not so pleasant.

Additionally, the door rug usually seen at the doorway of a company or a residence, no matter it is made of plastic, fabric or other material, it has the function of blocking the sand from the shoe sole; through a innovation oriented design, the said door rug can be very impressive to the visiting guest or client; however, all of the door rugs are laid or spread at the doorway and the traffic of passing-by people causes the door rug to slant, displace or curl; therefore, if the abovementioned situations can be eliminated through a special design, it will impress the visitors more.

In view of the abovementioned shortcomings of the fastening structures of the labeling plate body, the door rug, etc., the inventor of the present invention has researched and developed a plate body fastening structure to eliminate the problems derived from the conventional fastening and application of the labeling plate body and door rug.

### SUMMARY OF THE INVENTION

Specifically, the present invention of a plate body fastening structure mainly preserves a concave slot with a proper depth on a plane to be fastened, such as the outer wall of a building, the wall plane of a highrise, the floor plane at a doorway or an indoor wall; the said concave slot can be inserted by a figure plate, such as a labeling plate, a door rug, a writing or painting in smaller volume; a press stick is respectively and forcedly inserted between the peripheral sides of the figure plate and the inner wall plane of the concave slot to specifically position the figure plate inside the concave slot on the plane to be fastened so as to achieve the purposed effect of rapid detachment and specific positioning.

The primary objective of the present invention is that through the preserved concave slot on the said plane to be fastened with the forcedly inserted press stick, the figure plate can be rapidly removed and replaced to achieve the effect of specific positioning.

To enable a further understanding of the other objectives and the detailed structure of the present invention, the brief description of the drawings below is followed by the detailed description of the preferred embodiment.

### BRIEF DESCRIPTION OF THE DRAWINGS

FIG. 1 is an exploded drawing of the structure of the present invention.

FIG. 2 is a cross-sectional view drawing of the assembled structure of the present invention.

FIG. 3 is a state drawing of the present invention applied to a labeling plate body of a building.

FIG. 4 is a state drawing of the present invention applied to a door rug.

### DETAILED DESCRIPTION OF THE PREFERRED EMBODIMENTS

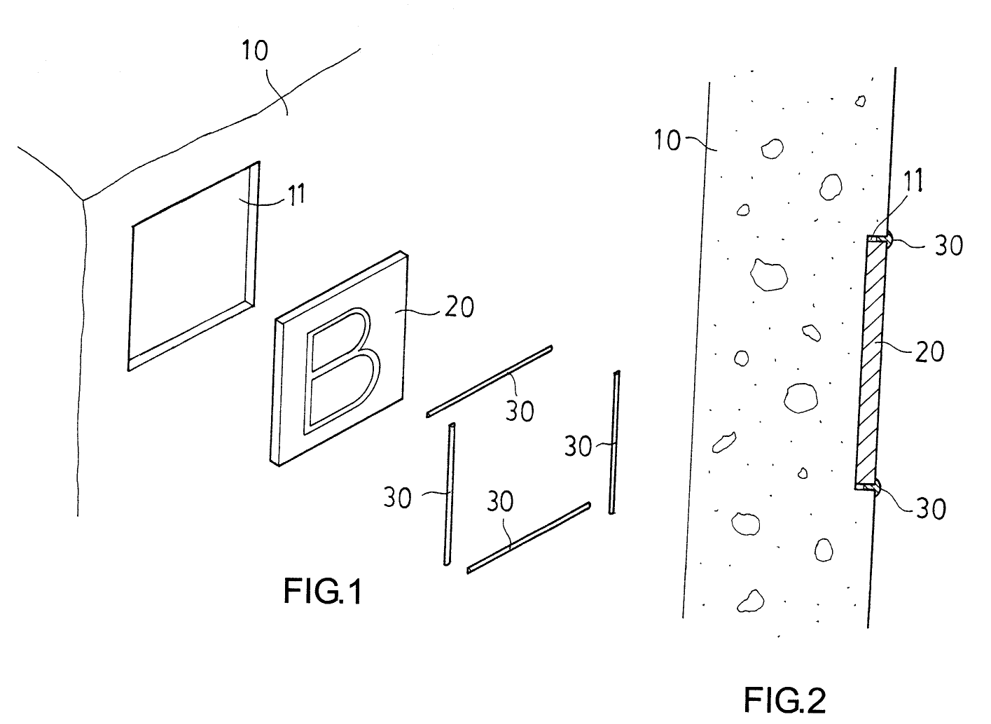

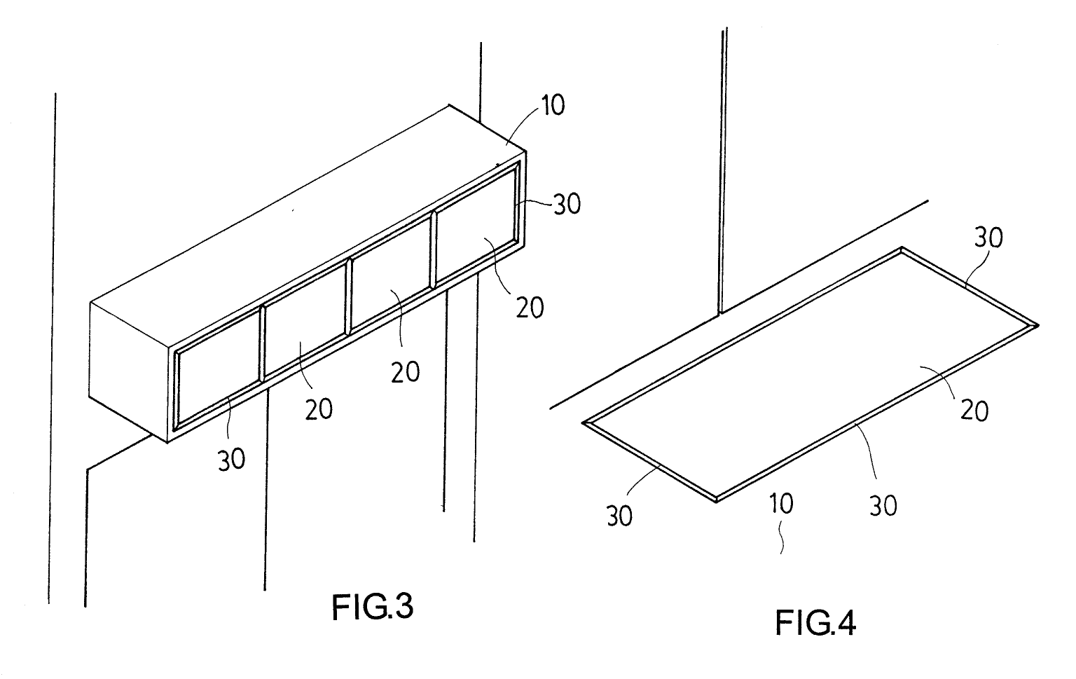

Referring from FIGS. 1 to 4, as indicated, the plate body fastening structure of the present invention mainly provides a fastening structure for rapidly detaching, replacing and specifically positioning a labeling plate, a door rug and a writing or a painting.

The said plate body fastening structure mainly preserves a concave slot (11) with a proper depth on a plane (10) to be fastened, such as the outer wall of a building, the wall plane of a highrise, the floor plane at a doorway or an indoor wall; the said concave slot (11) can be inserted by a figure plate (20), such as a labeling plate, a door rug, a writing or painting in smaller volume; a press stick (30) is respectively and forcedly inserted between the peripheral sides of the figure plate (20) and the inner wall plane of the concave slot (11) to specifically fasten the figure plate (20) to the plane (10) to be fastened in the concave slot (11) so as to achieve the purposed effect of rapidly removing, replacing and specifically positioning the labeling plate, the door rug and a writing or a painting.

The said figure plate (20) can be made of plastic, wood, stone, metal or any other synthetic plate bodies; the writing and figure presented on the plate can be molded by injecting, engraving and casting; the press stick (30) forcedly disposed between the concave slot (11) and the figure plate (20) is made of metal material; thereby, as a concave slot (11) is preserved on the outer wall of a building, a wall plane of a highrise, the floor plane at the doorway and the indoor wall, any labeling plate, door rug, writing and painting can be replaced and changed through the easy detachment, replacement and positioning of the press stick (30).

The preserved concave slot (11) allows the said labeling plate of the building to make the figure plate (20) be specifically inserted and fastened in the concave slot (11); that not only increases the convenience of replacing the labeling plate, but also eliminates the shortcomings of damaging or mending the outer wall.

Furthermore, through the pre-cast concave slot (11) fitted with the press stick (30), the figure plate, such as the labeling plate, the door rug, a writing or a painting, with various pattern or writing can be removed or assembled at will onto the wall plane of a highrise, the floor plane at the doorway or the indoor wall to increase the variation and convenience of applying the figure plate (20).

In summation of the abovementioned, the present invention completely complies with the patent requirements of industrial utilization, innovation and advancement.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A plate body fastening structure is characterized that:
the said plate body fastening structure mainly preserves a concave slot with a proper depth on a plane to be fastened, such as the outer wall of a building, the wall plane of a highrise, the floor plane at a doorway or an indoor wall; the said concave slot can be inserted by a figure plate in a smaller volume; a press stick is respectively and forcedly inserted between the peripheral sides of the figure plate and the inner wall plane of the concave slot to specifically position the figure plate inside the concave slot so as to achieve the purposed effect of rapidly detaching, replacing and specific positioning.

2. A plate body fastening structure according to claim 1, wherein the said figure plate can be any kind of labeling plate, door rug, writing and painting made of plastic, wood, stone, metal or any other synthetic plate bodies; the writing and figure presented on the plate can be molded through injecting, engraving and casting to be respectively fastened onto an outer wall of a building, a wall plane of a highrise, a floor plane at a doorway and a indoor wall.

3. A plate body fastening structure according to claim 1, wherein, the said press stick can be made of metal material.
